(19) United States
(12) Patent Application Publication
(10) Pub. No.: US 2008/0135540 A1
(43) Pub. Date: Jun. 12, 2008

(54) Container and cooker

(75) Inventors: Cindy Wu, Rosemead, CA (US); Lee K. Wu, Rosemead, CA (US)

Correspondence Address: Raymond Y. Chan, Suite 128, 108 N. Ynez Avenue, Monterey Park, CA, 91754, US

(73) Assignees: Lee K. WU; Cindy WU

(21) Appl. No.: 11/635,757

(22) Filed: Dec. 6, 2006

(51) Int. Cl. H05B 3/02; H05B 3/68; H05B 3/10

(52) U.S. Cl. 219/436; 219/451.1; 219/552

(57) ABSTRACT

A cooking set includes a heating unit, and a container. The heating unit has a top platform and a heat source provided thereon for generating heat. The container includes a container body and a heat enhancement arrangement. The container body includes a bottom wall and a surrounding wall upwardly extended from the bottom wall to form a heating cavity within the bottom wall and the surrounding wall. The heat enhancement arrangement contains a heat distributing cavity indently formed on the bottom wall of the container body to align with the heat source of the heating unit when the container body is disposed on the top platform of the heating unit, such that when the heating unit is controllably operated to generate the heat via the heat source, the heat is evenly accumulated within the heat distributing cavity to evenly distribute from the bottom wall to the surrounding wall.

### BACKGROUND OF THE PRESENT INVENTION

1. Field of Invention

The present invention relates to a cooking set, and more particularly to a cooker unit which is capable of evenly transmitting heat to a container so as to achieve efficient heat transfer between the cooker unit and the container.

2. Description of Related Arts

A conventional electric cooker usually comprises a heating base having a top heating platform formed thereon, and a heating module received within the heating base and thermally communicated with said top heating platform in such a manner that when a container is placed on top of the top heating platform, the heating module is arranged to transfer energy to the top heating platform which in turn transfers such energy to the container so as to heat up the object contained within the container. For example, if the container contains a predetermined amount of water, when the heating module is activated, energy is transferred to the top heating platform and then to the bottom surface of the container and finally to the water so as to heat up the temperature thereof. As a matter of conventional arts, the forms of energy which have been used to heat up the objects in the container includes electromagnetic radiation, as well as the more traditional form of electric heat generation. In the latter case, electrical energy is transformed into heat energy at the top heating platform which will become very hot. After that, the container is placed on top of the top heating platform for being heated up at predetermined temperature. However, this latter kind of conventional electric cooker has been utilized mainly for warm keeping, instead of “cooking” in the full sense.

There exist several disadvantages in relation to these conventional cookers. First, almost all containers rely on a single bottom surface as the main heat transmitting surface. In other words, the only way by which heat is transferred from the top heating platform to the container is through the bottom surface of the container. Thus, when one places the container onto the top heating platform, there is substantial chance that the container is misplaced onto the top heating platform (i.e. not at its central portion). Moreover, the container would slip out of the top heating platform very easily during the course of cooking.

Second, almost all conventional containers have more or less identical physical structure, which prohibits effective heat transfers when used in conjunction with the above-mentioned conventional heating bases. More specifically, a typical container usually has the above-mentioned bottom surface with a circular cross-section, wherein a diameter of the container is gradually increasing with increasing height. Thus, a top opening of the container is for convenient disposal of food, while the bottom surface is utilized for heat transfer and for inherent supporting purpose. From simple heat transfers theory, heat is transferred from the bottom surface to the, say, water, inside the container by conduction, whereas heat transfers within the container is by convection. It is a matter of general heat transfer theory that the effectiveness of heat transfer by conduction is higher than that of convection. Since heat transfer within the container is mainly by convection, it is predictable that it would take very long time for the heating base to heat up the objects, especially water, stored within the container. The situation is further aggravated when one takes into account that water is something which has a relatively high heat capacity. In other words, one needs substantial amount of energy to raise the water temperature and this will take very long time when conventional electric cookers are utilized.

Third, since heat transfer from the heating base to the container is by a combination of conduction and convection, there would certainly be substantially uneven distribution of heat within the container. For example, the objects which are placed at the outer side portion in the container are less cooked, while the objects placed at the central portion are relatively well cooked.

### SUMMARY OF THE PRESENT INVENTION

A main object of the present invention is to provide to a cooking set which comprises a heating unit and a container, wherein the cooker unit is capable of evenly transmitting heat to the container so as to achieve efficient and effective heat transfer between the cooker unit and the container.

Another object of the present invention is to provide a cooking set comprising a heat enhancement arrangement which contains a heat distributing cavity for accumulating and evenly transmitting heat to the container, so as to minimize heat loss from the heating unit to the surroundings.

Another object of the present invention is to provide a cooking set comprising a heat enhancement arrangement, wherein the container can be suitable for cooking a wide variety of food or liquid (such as water) or a mixture thereof (such as soup), so as to maximize the circumstances in which the present invention could be utilized.

Another object of the present invention is to provide a cooking set which does not involve complicated or expensive components so as to minimize the manufacturing cost of the present invention.

Accordingly, in order to accomplish the above objects, the present invention provides a cooking set, comprising:

a heating unit comprising a top platform and a heat source provided thereon for generating heat;

a container, which comprises a container body comprising a bottom wall and a surrounding wall upwardly extended from the bottom wall to form a heating cavity within the bottom wall and the surrounding wall; and

a heat enhancement arrangement, which contains a heat distributing cavity indently formed on the bottom wall of the container to align with the heat source when the container body is sat on the top platform of the heating unit, and comprises a heat transfer member which is provided on the top platform and is aligned with the heat distributing cavity for thermally transferring the heat from the heat source to the heat distributing cavity, such that when the heating unit is controllably operated to generate the heat via the heat source, the heat is evenly accumulated within the heat distributing cavity through the heat transfer member to evenly distribute the heat from the bottom wall to the surrounding wall so as to evenly and effectively heat up the heating cavity.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of a cooking set according to a preferred embodiment of the present invention.

FIG. 2 is a side view of the cooking set according to the above preferred embodiment of the present invention.

FIG. 3 is a first alternative mode of the cooking set according to the above preferred embodiment of the present invention.

FIG. 4 is a second alternative mode of the cooking set according to the above preferred embodiment of the present invention.

FIG. 5 is a third alternative mode of the cooking set according to the above preferred embodiment of the present invention.

### DETAILED DESCRIPTION OF THE PREFERRED EMBODIMENT

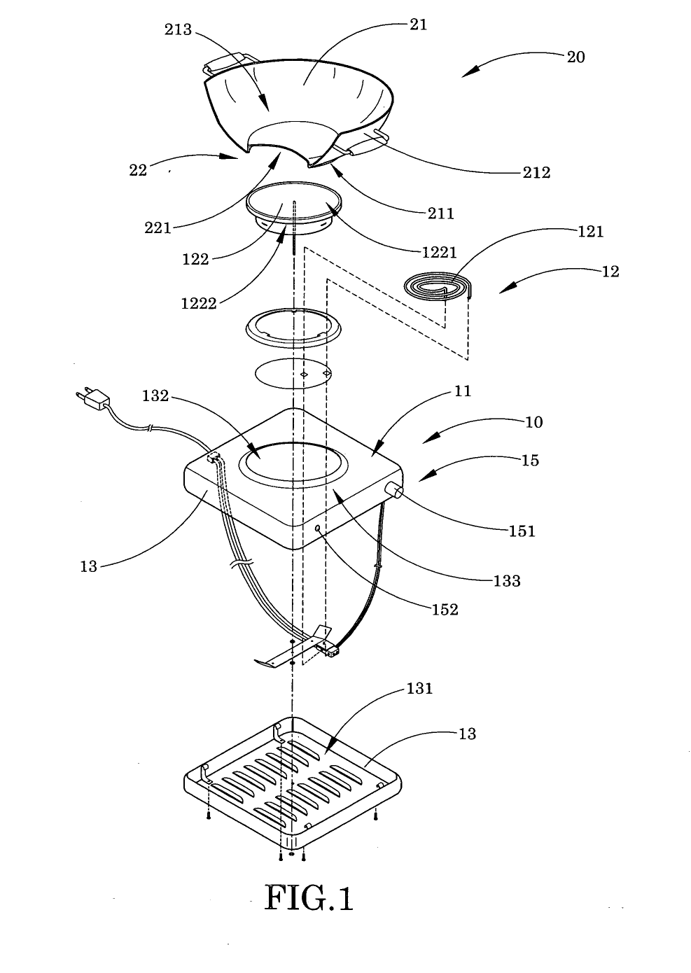

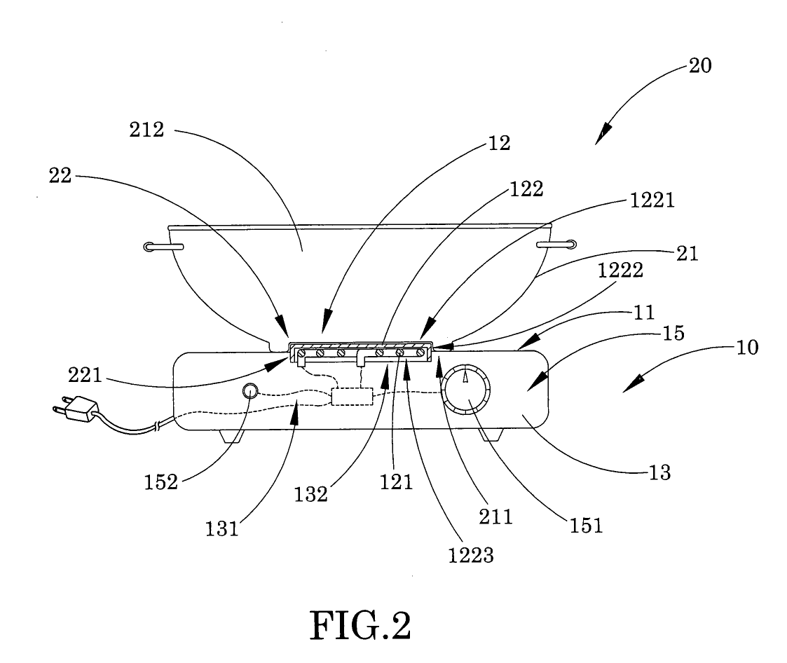

Referring to FIG. 1 to FIG. 2 of the drawings, a cooking set according to a preferred embodiment of the present invention is illustrated, in which the cooking set comprises a heating unit 10 and a container 20. The heating unit 10 has a top platform 11 and a heat source 12 provided thereon for generating heat.

The container 20 comprises a container body 21 and a heat enhancement arrangement 22. The container body 21 comprises a bottom wall 211 and a surrounding wall 212 upwardly extended from the bottom wall 211 to form a heating cavity 213 within the bottom wall 211 and the surrounding wall 212.

The heat enhancement arrangement 22 contains a heat distributing cavity 221 indently formed on the bottom wall 211 of the container 20 to align with the heat source 12 when the container body 21 is sat on the top platform 11 of the heating unit 10, and comprises a heat transfer member 122 which is provided on the top platform 11 and is aligned with the heat distributing cavity 221 for thermally transferring the heat from the heat source 12 to the heat distributing cavity 221, such that when the heating unit 10 is controllably operated to generate the heat via the heat source 12, the heat is evenly accumulated within the heat distributing cavity 221 through the heat transfer member 122 to evenly distribute the heat from the bottom wall 211 to the surrounding wall 212 so as to evenly and effectively heat up the heating cavity 213.

According to the preferred embodiment of the present invention, the heating unit 10 comprises an outer casing 13 having a receiving cavity 131 formed therein, and a through top opening 132 formed on a top surface 133 of the outer casing 13 to communicate with the receiving cavity 131, wherein the heat source 12 is mounted at the top opening 132 for delivering heat to the container body 21 via the heat enhancement arrangement 22.

The heat transfer member 122 is mounted at the outer casing 13, wherein the heat source 12 comprises a heating element 121 thermally communicated with the heat transfer member 122 in such a manner that when the heating element 121 is electrically connected with a power source, the heating element 121 is arranged to generate a predetermined amount of heat which is then transmitted to the heart transfer member 122.

More specifically, the heat transfer member 122 has a circular cross section corresponding with a circular cross section of the heat distributing cavity 221, and has a top heat transfer surface 1221 and a peripheral heat transfer surface 1222 which is upwardly extended from the top surface 133 of the outer casing 13, and peripherally surrounds the top heat transfer surface 1221 as a side wall of the heat transfer member 122, wherein the top heat transfer surface 1221 and the peripheral heat transfer surface 1222 are shaped and sized to fittedly correspond with the heat distributing cavity 221 of the heat enhancement arrangement 22 so that the container 20 is capable of fittedly engaging with the heating unit 10 at the top platform 11 for facilitating effective and efficient heat transfer from the heating unit 10 to the container 20, via the heat enhancement arrangement 22.

In other words, the heat transfer member 122 is upwardly protruded from the top platform 11 of the heating unit 10 at a position that the heat transfer member 122 is received in the heat distributing cavity 221 to evenly distribute the heat within the heat distributing cavity 221.

On the other hand, the heat distributing cavity 221 of the heat enhancement arrangement 22 is indently formed on the bottom wall 211 of the container body 21, wherein the heat distributing cavity 221 is shaped and sized to fit with the shape and size of the heat transfer member 122 of the heating unit 10. In other words, a diameter of the heat distributing cavity 221 is substantially the same (perhaps slightly smaller for ease of engagement) as the diameter of the heat transfer member 122, and a depth of the heat distributing cavity 221 is substantially the same as a height of the heat transfer member 122 for allowing fit and secure engagement between the heating unit 10 and the container 20. It is then worth mentioning that when the container 20 has fittedly engaged with the heating unit 10, the container body 21 is substantially retained on the heating unit 10 and its lateral movement with respective to the heat unit 10 is substantially restricted by the heat enhancement arrangement 22.

It is worth mentioning that the container body 21 has an uniform thickness such that when the heat distributing cavity 221 is indently formed on the bottom wall 211 of the container body 21, a corresponding portion of the bottom wall 211 is upwardly protruded within the heating cavity 213 so as to maximum a surface area of the heating cavity 213.

The heating element 121 is a spiral shaped electric heating element supported at the heating unit 10 for generating the heat, wherein the heat transfer member 122 has a bottom receiving cavity 1223 receiving the electric heating element 121 therein such that when the electric heating element 121 is operated, the heat generating therefrom is evenly distributed to the heat transfer member 122 for thermally transferring to the container body 21.

Referring to FIG. 1 to FIG. 2 of the drawings, the heating unit 10 further comprises a control device 15 provided on the outer casing 10 for controlling an operation of the heat source 12. More specifically, the control device 15 comprises temperature adjuster 151 operatively mounted on the outer casing 10 to electrically connect with the heat source 12, wherein the temperature adjuster 151 is adapted to adjust a temperature of the heat source 12 for adjusting the temperature at which the container 20 is heated. The control device 15 further comprises an operation indicator 152 provided on the outer casing 13 and electrically connected with the temperature adjuster 151 for indicating the status of the operation of the heat source 12.

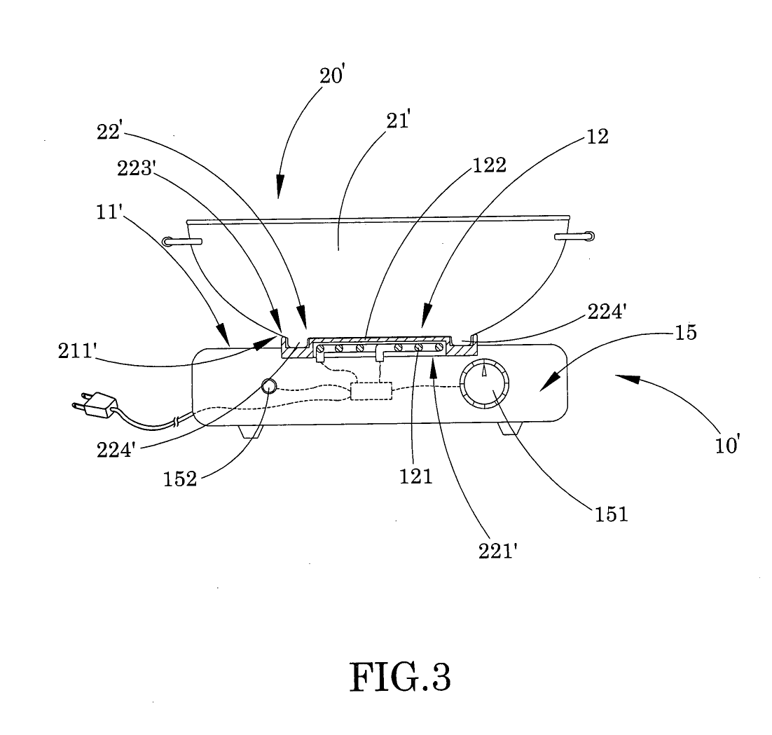

Referring to FIG. 3 of the drawings, a first alternative mode of the cooking set according to the preferred embodiment of the present invention is illustrated. The first alternative mode is similar to the preferred embodiment except the heat enhancement arrangement 22′. According to the first alternative mode, the heat enhancement arrangement 22′ further comprises a retention channel 223′ indently formed on the top platform 11′ of the heating unit 10′ and a retention rim 224′ which is downwardly and integrally extended from the bottom wall 211′ of the container body 21′ of the container 20′ at a position around the heat distributing cavity 221′ and is fittingly engaged in the retention channel 223′ when the container body 21′ is sat on the heating unit 10′ so as to not only ensure the heat transfer member 122′ aligning with the heat distributing cavity 221′ but also retain the container 20′ on the heating unit 10′ in position. The heat source 12, the heat transfer member 122 and the heating element 121 remain unchanged.

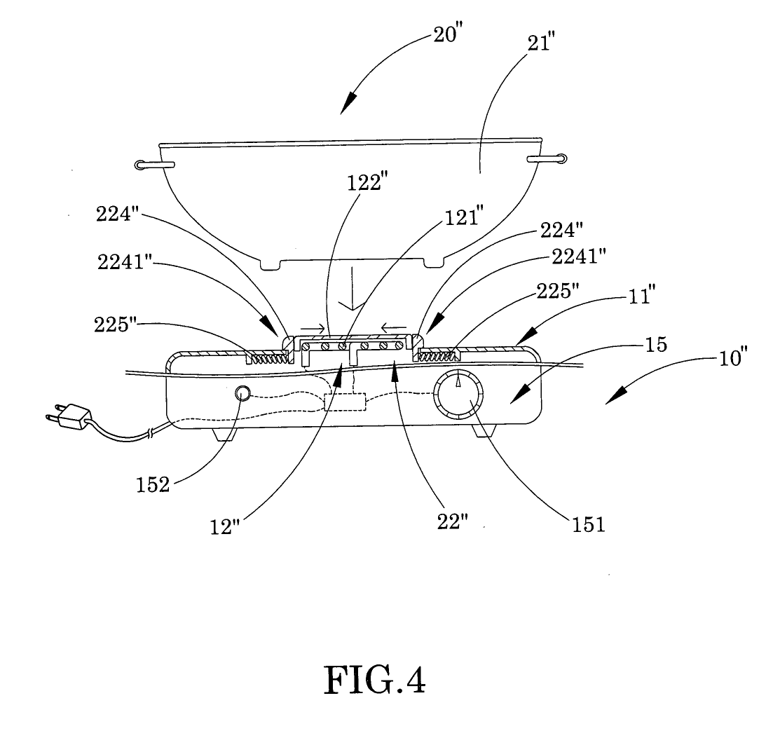

Referring to FIG. 4 of the drawings, a second alternative mode of the cooking set according to the preferred embodiment of the present invention is illustrated. The second alternative mode is similar to the preferred embodiment except the heat enhancement arrangement 22″. According to the second alternative mode, the heat enhancement arrangement 22″ further comprises at least two arc-shaped retention rims 224″ coaxially and upwardly extended from the top platform 11″ of the heating unit 10″ at a position around the heat source 12″ (and the heat transfer member 122″ and the heating element 121″) in a movably radial manner, and a plurality of resilient elements 225″ spacedly supported within the heating unit 10″ for applying a pulling force against the retention rims 224″ respectively such that when the container body 21″ of the container 20″ is sat on the heating unit 10′, the retention rims 224″ are biased against a peripheral wall of the heat distributing cavity 221″ so as to prevent a lateral movement of the container 20″ on the heating unit 10″.

Moreover, each of the retention rims 224″ has a curved top engagement surface 2241″ formed thereon, wherein when the container 20″ is sat on the heating unit 10″, the peripheral wall of the heat distributing cavity 221″ is engaged with the top engagement surface 2241″ to guide the retention rims 224″ slidably engaging with the peripheral wall of the heat distributing cavity 221″ until the retention rims 224″ are biased against the peripheral wall of the heat distributing cavity 221″ so as to ensure secure engagement between the heating unit 10″ and the container 20″.

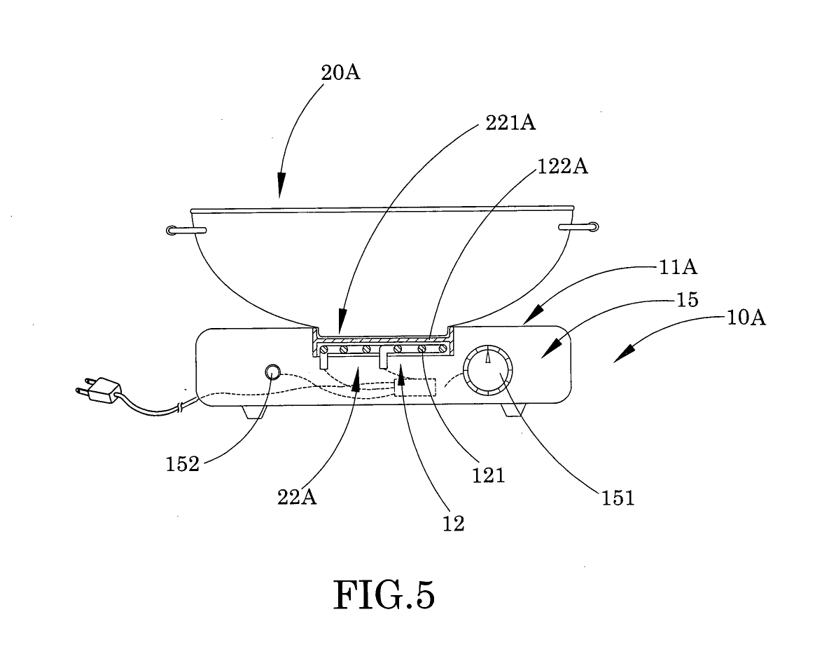

Referring to FIG. 5 of the drawings, a third alternative mode of the cooking set according to the preferred embodiment of the present invention is illustrated. The third alternative mode is similar to the preferred embodiment except the heat enhancement arrangement 22A. According to the third alternative mode, the positions of the heat transfer member 122A and the heat distributing cavity 221A are interchanged. Thus, the heat distributing cavity 221A is indently formed on the top platform 11A of the heating unit 10A, while the heat transfer member 122A of the heat enhancement arrangement 22A is extended from the bottom wall 211A of the container 21A for engaging with the heat distributing cavity 221A so as to facilitate the evenly distributed heat transfer from the heating unit 10A to the container 20A.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A cooking set, comprising:
a heating unit comprising a top platform and a heat source provided thereon for generating heat;
a container, which comprises a container body comprising a bottom wall and a surrounding wall upwardly extended from said bottom wall to form a heating cavity within said bottom wall and said surrounding wall; and
a heat enhancement arrangement, which contains a heat distributing cavity indently formed on said bottom wall of said container to align with said heat source when said container body is sat on said top platform of said heating unit, and comprises a heat transfer member which is provided on said top platform and is aligned with said heat distributing cavity for thermally transferring said heat from said heat source to said heat distributing cavity, such that when said heating unit is controllably operated to generate said heat via said heat source, said heat is evenly accumulated within said heat distributing cavity through said heat transfer member to evenly distribute said heat from said bottom wall to said surrounding wall so as to evenly and effectively heat up said heating cavity.

2. The cooking set, as recited in claim 1, wherein said heat transfer member is upwardly protruded from said top platform of said heating unit at a position that said heat transfer member is received in said heat distributing cavity to evenly distribute said heat within said heat distributing cavity.

3. The cooking set, as recited in claim 2, wherein a size of said heat transfer member is slightly smaller than a size of said heat distributing cavity such that when said heat transfer member is received in said heat distributing cavity, a peripheral wall of said heat distributing cavity forms a retention boundary to retain said container on said top platform so as to prevent a lateral movement of said container on said heating unit.

4. The cooking set, as recited in claim 2, wherein said heat transfer member has a circular shape corresponding to a circular shape heat distributing cavity such that when said heat transfer member is received in said heat distributing cavity, an outer surface of said heat transfer member contacts with an inner surface of said heat distributing cavity for maximizing a contact surface therebetween for heat transfer.

5. The cooking set, as recited in claim 3, wherein said heat transfer member has a circular shape corresponding to a circular shape heat distributing cavity such that when said heat transfer member is received in said heat distributing cavity, an outer surface of said heat transfer member contacts with an inner surface of said heat distributing cavity for maximizing a contact surface therebetween for heat transfer.

6. The cooking set, as recited in claim 1, wherein said container body has an uniform thickness such that when said heat distributing cavity is indently formed on said bottom wall of said container body, a corresponding portion of said bottom wall is upwardly protruded within said heating cavity so as to maximum a surface area of said heating cavity.

7. The cooking set, as recited in claim 3, wherein said container body has an uniform thickness such that when said heat distributing cavity is indently formed on said bottom wall of said container body, a corresponding portion of said bottom wall is upwardly protruded within said heating cavity so as to maximum a surface area of said heating cavity.

8. The cooking set, as recited in claim 5, wherein said container body has an uniform thickness such that when said heat distributing cavity is indently formed on said bottom wall of said container body, a corresponding portion of said bottom wall is upwardly protruded within said heating cavity so as to maximum a surface area of said heating cavity.

9. The cooking set, as recited in claim 2, wherein said heat enhancement arrangement further comprises a retention channel indently formed on said top platform of said heating unit and a retention rim which is downwardly and integrally extended from said bottom wall of said container body at a position around said heat distributing cavity and is fittingly engaged in said retention channel when said container body is sat on said heating unit so as to not only ensure said heat transfer member aligning with said heat distributing cavity but also retain said container on said heating unit in position.

10. The cooking set, as recited in claim 5, wherein said heat enhancement arrangement further comprises a retention channel indently formed on said top platform of said heating unit and a retention rim which is downwardly and integrally extended from said bottom wall of said container body at a position around said heat distributing cavity and is fittingly engaged in said retention channel when said container body is sat on said heating unit so as to not only ensure said heat transfer member aligning with said heat distributing cavity but also retain said container on said heating unit in position.

11. The cooking set, as recited in claim 8, wherein said heat enhancement arrangement further comprises a retention channel indently formed on said top platform of said heating unit and a retention rim which is downwardly and integrally extended from said bottom wall of said container body at a position around said heat distributing cavity and is fittingly engaged in said retention channel when said container body is sat on said heating unit so as to not only ensure said heat transfer member aligning with said heat distributing cavity but also retain said container on said heating unit in position.

12. The cooking set, as recited in claim 5, wherein said heat source comprises a spiral shaped electric heating element supported at said heating unit for generating said heat, wherein said heat transfer member has a bottom receiving cavity receiving said electric heating element therein such that when said electric heating element is operated, said heat generating therefrom is evenly distributed to said heat transfer member for thermally transferring to said container body.

13. The cooking set, as recited in claim 8, wherein said heat source comprises a spiral shaped electric heating element supported at said heating unit for generating said heat, wherein said heat transfer member has a bottom receiving cavity receiving said electric heating element therein such that when said electric heating element is operated, said heat generating therefrom is evenly distributed to said heat transfer member for thermally transferring to said container body.

14. The cooking set, as recited in claim 11, wherein said heat source comprises a spiral shaped electric heating element supported at said heating unit for generating said heat, wherein said heat transfer member has a bottom receiving cavity receiving said electric heating element therein such that when said electric heating element is operated, said heat generating therefrom is evenly distributed to said heat transfer member for thermally transferring to said container body.

15. The cooking set, as recited in claim 2, wherein said heat enhancement arrangement further comprises at least two arc-shaped retention rims coaxially and upwardly extended from said top platform of said heating unit at a position around said heat source in a movably radial manner and a plurality of resilient elements spacedly supported within said heating unit for applying a pulling force against said retention arms respectively such that when said container body is sat on said heating unit, said retention rims are biased against a peripheral wall of said heat distributing cavity so as to prevent a lateral movement of said container on said heating unit.

16. The cooking set, as recited in claim 15, wherein said each of said retention rims has a curved top engagement surface formed thereon, wherein when said container is sat on said heating unit, said peripheral wall of said heat distributing cavity is engaged with said top engagement surface to guide said retention rims slidably engaging with said peripheral wall of said heat distributing cavity until said retention rims are biased against said peripheral wall of said heat distributing cavity so as to ensure secure engagement between said heating unit and said container.

17. The cooking set, as recited in claim 15, wherein said container has an uniform thickness such that when said heat distributing cavity is indently formed on said bottom wall of said container, a corresponding portion of said bottom wall is upwardly protruded within said heating cavity so as to maximum a surface area of said heating cavity.

18. The cooking set, as recited in claim 16, wherein said container has an uniform thickness such that when said heat distributing cavity is indently formed on said bottom wall of said container, a corresponding portion of said bottom wall is upwardly protruded within said heating cavity so as to maximum a surface area of said heating cavity.

19. The cooking set, as recited in claim 15, wherein said heat source comprises a spiral shaped electric heating element supported at said heating unit for generating said heat, wherein said heat transfer member has a bottom receiving cavity receiving said electric heating element therein such that when said electric heating element is operated, said heat generating therefrom is evenly distributed to said heat transfer member for thermally transferring to said container body.

20. The cooking set, as recited in claim 18, wherein said heat source comprises a spiral shaped electric heating element supported at said heating unit for generating said heat, wherein said heat transfer member has a bottom receiving cavity receiving said electric heating element therein such that when said electric heating element is operated, said heat generating therefrom is evenly distributed to said heat transfer member for thermally transferring to said container body.
